(19) United States
(12) Patent Application Publication
(10) Pub. No.: US 2001/0045499 A1
(43) Pub. Date: Nov. 29, 2001

(54) Ergonomic die horse

(76) Inventors: Douglas Wheaton, Lakewood, OH (US); Anthony J. Mazzella, Olmsted Falls, OH (US)

Correspondence Address: Roger D. Emerson, Fourteenth Floor, One Cascade Plaza, Akron, OH, 44333-1343, US

(21) Appl. No.: 09/777,951

(22) Filed: Feb. 6, 2001

Related U.S. Application Data
(60) Provisional application No. 60/180,077, filed on Feb. 3, 2000.

(51) Int. Cl. F16M 11/00

(52) U.S. Cl. 248/161

(57) ABSTRACT

An easily maneuverable and transportable die horse that utilizes swivel spring-loaded casters is provided. The die horse is comprised of the customary top and legs wherein the legs are connected to the top and extend outwardly and downwardly therefrom, a support brace is secured across the legs and a base mounted to the legs parallel to and below the top and at least one swivel spring-loaded caster means, commonly known in the industry, mounted to the die horse. The spring-loading of the caster means allows the spring to support the die horse in an unloaded state thus allowing a user to easily manipulate the die horse. When the die horse is loaded, the weight of the die horse exceeds the biasing of the spring causing the bottom portion of the legs to contact the floor, thus preventing movement thereof.

### BACKGROUND OF THE INVENTION

This utility patent application claims priority from a Provisional Application having serial No. 60/180,077, which was filed on Feb. 3, 2000. Inventorship has remained unchanged.

### I. FIELD OF THE INVENTION

The present invention relates to die horses and, more particularly, to a die horse that is easily maneuvered by a user thereby being ergonomic.

### II. DESCRIPTION OF THE RELATED ART

The present invention contemplates a new and improved die horse which is simple in design, effective in use, and overcomes the foregoing difficulties and others while providing better and more advantageous overall results.

A die horse is a weight bearing structure that is commonly used in industrial settings to support loads. Typically, the die horse is used to support a die load, but it may also be used to support other types of loads. These loads can often weigh in excess of one hundred thousand pounds. As a result, the die horse must be manufactured from material that can withstand such loads. Steel is usually used, although any material that imparts sufficient strength to the die horse may be used. Unfortunately, these materials also make the die horse extremely heavy and difficult to move. It commonly takes the combined efforts of several people, or a mechanical system, such as a crane to move a die horse. The die horse, therefore, must be manually pushed/pulled to a new location (or moved with a crane), which can cause lower back strain and other medical problems.

The present invention attempts to overcome these deficiencies in the prior art die horses by providing for a die horse that is easily maneuvered and transported. This is accomplished by mounting swivel spring loaded casters to the die horse. In an unloaded state the springs support the die horse thereby allowing the die horse to be easily maneuvered and transported. When the die horse supports a load, the legs of the die horse contact the floor thereby supporting the load.

### SUMMARY OF THE INVENTION

In accordance with the present invention, a new and improved die horse is provided which can be easily maneuvered and transported from one location to another yet still provide the benefits of the prior art die horses.

One objective of this invention to provide a die horse that meets the American Society of Mechanical Engineer's ANSI standards for load rating and has the advantage of being ergonomic in its maneuverability such that a crane or manual manipulation of the die horse is no longer needed.

It is still a further objective of the invention to provide a die horse that meets ANSI requirements for load rating and has the advantage of being ergonomic in its maneuverability such that a crane or pushing of the die horse is no longer needed.

It is still a further objective of this invention to provide a die horse that can be easily maneuvered and manually manipulated.

It is still a further objective of this invention to provide a die horse that is easily and efficiently manufactured and marketed.

It is still a further objective of this invention to provide a die horse that is of durable and reliable construction.

It is still a further objective of this invention to provide a die horse that has all of the advantages of the prior art die horse and none of the disadvantages.

To accomplish these objectives, the present invention provides for a die horse that is supported by swivel spring loaded casters. In one embodiment, the die horse has the customary top and legs wherein the legs are connected to the top and extend outwardly and downwardly therefrom, a support brace connected across the legs, a base mounted to the legs parallel to and below the top and at least one swivel spring-loaded caster means, commonly known in the industry, mounted to the die horse. The spring loading of the caster means allows the spring to support the die horse in an unloaded state, thus allowing a user to easily manipulate the die horse. When the die horse is loaded, the weight of the die horse exceeds the biasing of the spring causing the bottom portion of the legs to contact the floor, thus preventing movement thereof.

In an alternate embodiment of the invention, a die horse is provided that has a top, a bottom, two trapezoidal end panels, a base mounted to the trapezoidal end panels parallel to and in between the top and bottom, four legs attached to the comers of the bottom and at least one swivel spring-loaded caster means.

In another alternate embodiment of the invention, a die horse is provided that has a top, a bottom, two rectangular end panels, a base mounted to the trapezoidal end panels parallel to and in between the top and bottom, four legs attached to the corners of the bottom and at least one swivel spring-loaded caster means.

Still other benefits and advantages of the invention will become apparent to those skilled in the art upon a reading and understanding of the following detailed specification.

### BRIEF DESCRIPTION OF THE DRAWINGS

The invention may take physical form in certain parts and arrangement of parts. A preferred embodiment of these parts will be described in detail in the specification and illustrated in the accompanying drawings, which form a part of this disclosure and wherein:

FIG. 1 is an end view of the invention wherein the die horse is in unloaded state;

FIG. 2 is a side view of the invention wherein the die horse is in an unloaded state;

FIG. 3 is an end view of a second embodiment of the present invention wherein the die horse is in an unloaded state;

FIG. 4 is a side view of the second embodiment of the present invention of FIG. 3 wherein the die horse is in an unloaded state;

FIG. 5 is an end view of the third embodiment of the present invention wherein the die horse is in an unloaded state; and,

FIG. 6 is a side view of the third embodiment of the present invention wherein the die horse is in an unloaded state.

### DESCRIPTION OF THE PREFERRED EMBODIMENT

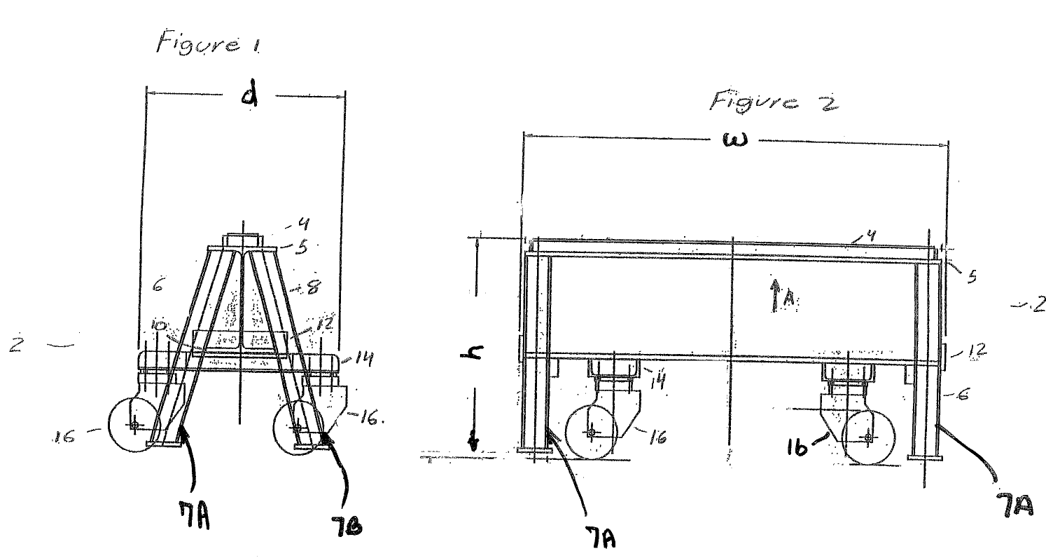

Referring now to the drawings, which are for purposes of illustrating a preferred embodiment of the invention only, and not for purposes of limiting the invention, FIGS. 1-6 show preferred embodiments of the invention wherein a die horse 2 is in an unloaded state.

With reference to FIGS. 1 and 2, a conventional die horse 2 is illustrated having a top 4, and a rectangular plate 5. The rectangular plate 5 has a front end and a rear end, which are secured to the top 4 and first and second support means 7A and 7B. In the embodiment shown in FIGS. 1 and 2, the first and second support means 7A and 7B are a pair of front legs 6 and a pair of rear legs 8. The rectangular plate is secured to the top 4 and the front, rear legs 6 and 8, typically, by welding although any means to secure the plate 5 are within the scope of this invention. The pair of front, rear legs 6, 8 are secured to the plate 5 and extend downwardly and outwardly therefrom forming an inverted “V” shape. A support brace 12 is mounted across each pair of legs 6, 8 to provide stability to the die horse 2. Similarly, the support brace 12 is mounted to the legs 6, 8 by welding, although once again, any means to secure the brace 12 is within the scope of this invention.

The front pair of legs 6 are secured to the bottom of the rectangular plate 5 towards, and horizontal to, the front end of the rectangular plate 5. Similarly the rear pair of legs 8 are secured to the bottom of the rectangular plate 5 toward, and horizontal to the rear end of the plate 5. Typically, the front and rear pair of legs 6 and 8 are secured to the plate 5 with screws, but any means, such as nuts and bolts, adhesives or other securing means, which secures the legs 6 and 8 to the rectangular plate 5, may be used.

The support brace 12 is mounted across each pair of legs 6 and 8 at a predetermined distance from the top 4 to maximize stability. Typically, the support brace 12 is welded to the legs 6 and 8, but any means such as screws, adhesives or other mounting means, which mounts (or secures) the support brace 12 to the legs 6 and 8, may be used. As shown in FIGS. 1 and 2, the die horse 2 may range in overall height h from substantially twenty inches to substantially thirty inches. The width w may range from substantially forty-five inches to substantially fifty-five inches. The depth d may range from substantially twenty inches to substantially twenty-five inches. although the present invention is not limited to these dimensions. Any dimensions may be chosen utilizing sound engineering judgment provided the die horse 2 has adequate support.

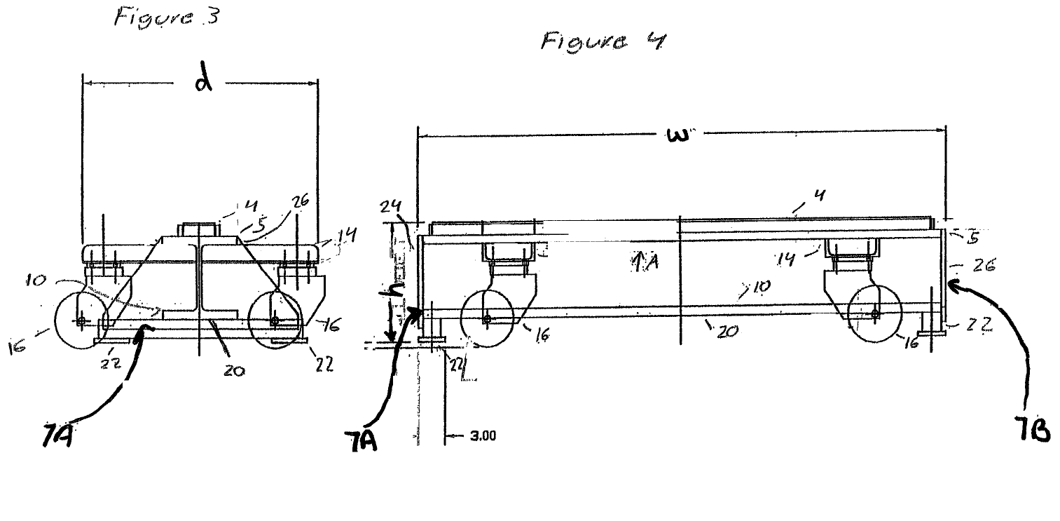

With reference to FIGS. 3 and 4, an alternate embodiment of the die horse 2 is illustrated having a top 4 and a rectangular plate 5. The rectangular plate has a front end and a rear end, which are secured to the top 4, and the first and second support means 7A, 7B are two trapezoidal sides 24 and 26. The rectangular plate 5 is secured to the top 4 and the two trapezoidal sides 24 and 26, typically, by welding although any means to secure the plate 5 are within the scope of this invention. The first and second support means 7A, 7B also includes a bottom 20 and legs 22. The bottom 20 is secured to the sides, typically by welding, but again, any means that secures the bottom 20 is with the scope of this invention. Four legs 22 are secured to each corner of the bottom 20. Typically, the legs 22 will be secured to the bottom 20 with screws, but any means, such as nuts and bolts, adhesives or other securing means, which secures the legs to the bottom 20, may be used. As shown in FIGS. 3 and 4, the height h of the die horse 2 may range from approximately ten inches to substantially twenty inches. The width w may range from approximately fifty inches to seventy inches. Further, the depth d may range from substantially twenty-five to thirty inches. Any dimensions may be chosen utilizing sound engineering judgment provided the die horse 2 has adequate support.

With reference to FIGS. 5 and 6, another alternate embodiment of the die horse 2 is illustrated having a top 4 and a rectangular plate 5. The rectangular plate 5 has a front end and a rear end, which are secured to the top 4. The first and second support means 7A, 7B are two rectangular sides 28 and 30. Typically, the rectangular plate 5 will be secured to the rectangular sides 28 and 30 by welding, but any means, such as nuts and bolts, adhesives or other securing means, which secures the rectangular plate 5 to the bottom 20, may be used. As in the previous embodiment, the first and second support means 7A, 7B also includes the bottom 20 and legs 22. The bottom 20 is also secured to the rectangular sides 28 and 30, typically by welding, but once again, any means that secures the bottom 20 is with the scope of this invention. Four legs 22 are secured to each corner of the bottom 20. Typically, the legs 4 will be secured to the bottom 20 with screws, but any means, such as nuts and bolts, adhesives or other securing means, which secures the legs 22 to the bottom 20, may be used. As shown in FIGS. 5 and 6, the height h of the die horse 2 may range from approximately twenty inches to substantially thirty inches. The width w may range from approximately forty-five inches to fifty-five inches. Further, the depth d may range from substantially twenty inches to twenty-five inches. Any dimensions may be chosen utilizing sound engineering judgment provided the die horse 2 has adequate support.

In FIGS. 1-6, the plate 5 is located beneath the top 4 and secured flush to the top 4. Typically, the top 4 will be secured to the plate 5 with screws or welding, but any means, such as nuts and bolts, adhesives or other connective means, which secures the top 4 to the rectangular plate 5, may be used.

In FIGS. 1-6, the top 4 may be composed of any material sufficient to support the weight of the load, but in the preferred embodiment the top 4 is comprised of a sheet of wood enclosed in steel. In the FIGS. 1-6, the legs 6, 8, 22 are connected to the rectangular plate 5, but the legs 6, 8, 22 may be directly connected to the top 4.

In FIGS. 1-6, the die horse 2 is composed of either two pairs of legs 6 and 8 or four individual legs 22, but the die horse 2 may be composed of two or more individual or pairs of legs positioned in any arrangement sufficient to support the die horse 2 and the load, in a loaded state. In FIGS. 1 and 2, die horse 2 is composed of a support brace 12, but depending on the load and the strength the die horse 2, such support may not be needed. Conversely, a support brace 12 may added the alternate die horses 2 illustrated in FIGS. 3-6, if additional support is desired.

In FIGS. 1-6, additional support is also provided to the die horse 2 by a base 10 that is located below and extending parallel to the top 4. The base 10 is connected to either the legs 6 and 8 or the sides 24, 26, 28, 30 at a predetermined distance from the top 4 to maximize stability. Typically, the base 10 is welded to the legs 6 and 8 or the sides 24, 26, 28, 30, but any means such as screws, adhesives or other connective means, which secure the base 10 to the legs 6 and 8 or the sides 24, 26, 28, 30 may be used. Although the base 10 is used to provide additional support to the die horse, depending on the load and the strength of the die horse 2, such supports may not be needed.

The foregoing structure is representative of that which is well known in the art. Unfortunately, as a consequence of the weight and equipment described, maneuvering the die horse 2 is difficult and often requires a crane.

The present invention corrects this problem by the utilization of a swivel spring-loaded caster means 16, as is commonly known in the industry, to facilitate maneuverability of the die horse 2. A swivel spring loaded caster 16 is mounted to the die horse 2.

In an unloaded state, the springs support the die horse 2 thereby allowing the die horse 2 to be easily maneuvered. When the die horse 2 supports a load, the legs 6, 8, 22 of the die horse 2 contact the ground 18, thereby supporting the load. The die horse 2 must be connected to at least one swivel spring-loaded caster means 16. The swivel spring-loaded caster means 16 may be attached to the die horse 2 in any manner, provided the die horse 2 is supported by the springs in an unloaded state and supported by the legs 6, 8, 22 in a loaded state.

In FIGS. 1 and 2, two hollow “U” tubes 14 are connected to the bottom of the base 10, parallel to, and at a predetermined distance from the front 6 and rear pair of legs 8. In FIGS. 3-6, two hollow “U” tubes 14 are connected to the bottom of the top 4, (or rectangular plate 5), parallel to and at a predetermined distance from the sides 24, 26, 28, 30. Typically, the two hollow “U” tubes are welded to either the base 10 or the top 4, but any means such as screws, adhesives or other securing means, which secure the two hollow “U” tubes 14 to either the base 10 or the top 4, may be used.

A swivel spring-loaded caster means 16, as is commonly known in the industry, is connected to each end of the two hollow “U” tubes 14. Typically, screws will be used to mount the spring loaded casters 16 to the two hollow “U” tubes 14, but any means such as nuts and bolts, adhesives or other securing means, which secure the swivel spring-loaded caster 16 to the hollow “U” tubes 14 may be used. These embodiments allow the die horse 2 to be easily maneuvered in an unloaded state, while simultaneously allowing the legs 6, 8, 22 to contact the underlying support surface 18 and support the load when the die hoarse 2 is unloaded.

In operation, this embodiment allows the die horse 2 to be easily transported. In its loaded state, the die horse 2 is immovable. As a sufficient load is applied to the die horse 2, the load overcomes the biasing of the spring and the legs 6, 8, 22 contact the ground 18 making the die horse 2 immovable. The casters are moved in the upward direction of Arrow A until they become flush with the ground 18 at which point they continue to contact the ground but are no longer providing support to the die horse 2 or the load.

When transportation of the die horse 2 is desired, a user merely has to remove the load from the die horse 2 in the upward direction of Arrow A. As the load is removed from the die horse 2, the springs support the load of the die horse 2, move the casters in the downward direction of Arrow B and the casters support the die horse 2. This allows a user to easily maneuver and transport the die horse 2 by either pulling or pushing it, with much less force than what would otherwise be needed since the die horse 2 is supported by the casters and, thus easily moveable.

The invention has been described with reference to the preferred embodiment. Obviously, modifications and alterations will occur to others upon a reading and understanding of the specification. It is intended by applicant to include all such modifications and alterations insofar as they come within the scope of the appended claims or the equivalents thereof.

What is claimed is:

1. A die horse having a loaded and unloaded state, the die horse comprising:
first support means;
second support means;
a top operatively connected to said first and second support means and extending substantially horizontally therebetween; and,
at least one biasing means operatively connected to said top, wherein said biasing means supports said die horse during the unloaded state, and when said die horse is in said loaded state, the load overcomes said biasing means and said first and second support means contact the underlying support surface.
